(19) United States
(12) Patent Application Publication
(10) Pub. No.: US 2002/0067881 A1
(43) Pub. Date: Jun. 6, 2002

(54) Polarization independent coupler with bragg-evanescent-coupler grating

(76) Inventor: Stephen R. Mathis, Menifee, CA (US)

Correspondence Address: Donald E. Stout, Stout, Uxa, Buyan & Mullins, LLP, Suite 300, 4 Venture, Irvine, CA, 92618, US

(21) Appl. No.: 09/799,461

(22) Filed: Mar. 6, 2001

Related U.S. Application Data
(60) Provisional application No. 60/187,363, filed on Mar. 6, 2000.

(51) Int. Cl. G02B 6/28

(52) U.S. Cl. 385/24

(57) ABSTRACT

Devices for use in optical telecommunication networks are capable of efficiently adding or dropping any channel or selection of channels, accommodating the demand for dense wavelength division channel spacing, and providing a method for constructing an optical network composed entirely of optical fiber devices. The devices combine the best attributes of the fused biconic taper coupler WDM (which provides low loss) and the fiber optic Bragg grating (which provides superior channel resolution) to achieve low loss, high resolution channel spacing devices that are practical to manufacture. In one embodiment, there is provided a device for use in an optical telecommunication network, which comprises a first PINC-BEC having an input for receiving channels comprising wavelength bands λ₁₋ₙ, where n is a number greater than 2, and a plurality of outputs. This first PINC-BEC has a first Bragg grating for selectively isolating a desired one of the input channels from the remaining channels input into the PINC-BEC. The inventive system further comprises a second PINC-BEC having an input for receiving the remaining channels from an output of the first PINC-BEC and further filtering the desired one of the input channels from the input to the second PINC-BEC. Preferably, a Bragg grating is disposed between the first and second PINC-BECs to improve the isolation of the selected channel.

### BACKGROUND OF THE INVENTION

This invention relates generally to optical telecommunication network devices, and in particular to Wavelength Division Multiplexers (WDM), Optical Add Drop Multiplexers (OADM), and related fiber optic devices.

Communication networks exhibit an insatiable desire for increased capacity. Every year, technological advances offer vast increases in transmission capacity, but new capabilities do not keep up with demand. Many researchers are currently developing new discrete optical devices aimed at improving transmission capacity, but optimum system architectures have been elusive.

The ability to increase fiber optic transmission capacity is limited by the capability to add more and more channels in a single optical fiber transmission window. The International Telecommunications Network Union (ITU) grid is rapidly becoming a standard, and typically specifies 200 GHz, 100 GHz, and 50 GHz channel spacing, and is presently looking towards 25 GHz spacing. With this in mind, there is a need for devices that can add or drop each of these channels to form a network. Some devices can now meet this requirement, and are promising Dense Wavelength Division Multiplexer (DWDM) networks of 80 or more channels in the 1.55 μm wavelength transmission window. However, these networks have not been optimized for optical power transmission.

Some devices, such as the fused biconic taper coupler WDM now offer low loss (e.g. <0.2 dB) polarization independent transmission, yet the channel spacing does not meet industry requirements. Other devices offer very high-resolution channel spacing (such as the fiber optic Bragg grating in the Mach-Zehnder configuration), but the losses associated with the devices are excessive. Furthermore, the ability to select particular wavelengths for a specific application, or to balance the power output from a multi-channel network, has not been demonstrated.

New systems now require much tighter spacing in order to achieve systems transmitting 80 or more channels in a single transmission band, i.e., the 1.55 μm band. Such a device, a “fusion coupler”, has been achieved by Snitzer as disclosed in U.S. Pat. No. 5,574,807, and is comprised of an evanescent wave coupler and a fiber optic Bragg grating coupler, hereinafter defined as a Bragg-Evancescent-Coupler (BEC). The coupler relies on evanescent field coupling of light from one waveguide to the other, and the Bragg grating is disposed in the coupling region in each of the waveguides. The Bragg grating is reflective to a narrow band of light traversing the coupling region, and thus is capable of adding or dropping the desired channel.

However, the device disclosed in the '807 patent to Snitzer requires that two waveguides be placed in close proximity and fused. FIG. 1 of the '807 patent comprises two substantially identical single-mode fibers having similar cores, and are fabricated so that there is substantially complete evanescent field coupling of light from one core to the other in a predetermined wavelength band. The '807 patent system maintains two distinct waveguides. Tolerances on the length of the coupling region must be controlled to fractions of a wavelength. The spacing and fusion length is critical to device performance. This is a significant disadvantage to such a device. Alignment tolerances during fabrication make the tooling requirements expensive, and the relative cost to manufacture prohibitive.

A similar device is disclosed in U.S. Pat. No. 5,805,751 to Kewitsch. As in the '807 patent to Snitzer, the devices disclosed in the '751 patent to Kewitsch are made using evanescent wave couplers. FIG. 1 of the '751 patent illustrates the basic device, which is a grating assisted mode coupler. Couplers in the '751 patent are defined as “a waveguide composed of two or more fibers placed in close proximity of one another, the proximity being such that the mode fields of the adjacent waveguides overlap to some degree”. As in the '807 patent, required alignment tolerances of such devices make the manufacturing complexity prohibitive. In addition, unlike the inventive device which will be disclosed hereinbelow, the Kewitsch device uses “dissimilar waveguides” to eliminate undesired leakage of optical energy between waveguides.

U.S. Pat. No. 5,121,453 discloses a “Polarization Independent Narrow Channel Wavelength Division Multiplexing Fiber Coupler and Method for Producing Same”. As discussed therein, fusion type couplers made with single mode fiber generally exhibit a dependence on polarization because of inherent birefringence, and the fraction of power coupled into each polarization is generally not the same. With this being the case, transmission of unpolarized light makes it unrealizable to fabricate an efficient low crosstalk WDM coupler if the birefringence effect is not mitigated.

The system in the '453 patent overcomes the general problem of polarization dependence by measuring the conditions when these devices become polarization independent, and reproducing those conditions during fabrication. Specifically, the patent explains that if the coupler elongation region made during the fusion process is drawn to a length where the envelope of power transfer cycles (referring to the power transferred between adjacent fibers) reaches a maximum, then complete coupling can be obtained independent of polarization.

Using this method, a Polarization Independent Coupler (PINC) can be fabricated that exhibits a channel crosstalk of less than −20 dB using narrow band laser sources with center wavelength spacing less than or equal to 35 nm. At present, their techniques have been advanced so that a center wavelength spacing of 4-5 nm can be made practicable. In addition, the excess loss of these devices has been reduced to approximately 0.2 dB.

At the present time, BEC devices have been demonstrated to achieve stable channel spacing on the ITU grid of 50 (0.4 nm). Since these are reflective devices, they can only be used following demultiplexing couplers.

To maximize the isolation between channels and minimize crosstalk, the general practice is to maximize the reflectivity of the BEC device. However, this yields some problems. Manufacturing tolerances must be closely controlled to achieve the required performance, making the manufacturing process more complex, and increasing the cost. In addition, this also results in a low manufacturing throughput rate when devices that do not meet the required specifications are rejected. Furthermore, performance issues associated with high reflectivity devices include potential damage of such devices in high signal strength systems, and ringing effects (producing bit-errors in digital transmission systems) when signals bounce between pairs of highly reflective gratings.

It would be advantageous to have a system with the ability to add or drop any channel, or selection of channels, on a fiber optic network as efficiently as possible. The term “efficiently” means the optimization of network architecture such that the excess losses of each channel are minimized. Another advantageous feature would be to accommodate the demand for dense wavelength division channel spacing. Additionally, it would be useful to have a method for constructing an efficient fiber optic network using all fiber optic devices (as opposed to integrated optic or micro-optic devices), since devices comprised entirely of fiber optics are inherently simpler to manufacture, and match the optical properties of the transmission media itself, potentially eliminating transmission losses at device interfaces.

### SUMMARY OF THE INVENTION

The present invention uniquely meets the objectives outlined above, and solves the problems in the prior art, by providing devices for use in optical telecommunication networks which are capable of efficiently adding or dropping any channel or selection of channels, accommodating the demand for dense wavelength division channel spacing, and providing a method for constructing an optical network composed entirely of optical fiber devices. The inventive system combines the best attributes of the fused biconic taper coupler WDM (which provides low loss) and the fiber optic Bragg grating (which provides superior channel resolution) to achieve low loss, high resolution channel spacing devices that are practical to manufacture.

Thus, stated another way, in the present invention, an improvement is added to the PINC device disclosed in the '453 patent discussed supra, in that a Bragg grating is added thereto to decrease the channel spacing, while yet preserving the advantage of very low excess loss inherent in the PINC device. The present invention differs from the systems taught in the Kewitsch and Snitzer patents discussed supra, in that it is based on a PINC device, comprises a longer and less wavelength-sensitive coupling region, and is far more practical to manufacture since alignment tolerances are reduced. In addition, the Kewitsch device comprises dissimilar waveguides.

More particularly, in one aspect of the invention there is provided a device for use in an optical telecommunication network, which comprises a first PINCBEC having an input for receiving channels comprising wavelength bands λ₁₋ₙ where n is a number greater than 2, and a plurality of outputs. This first PINC-BEC has a first Bragg grating for selectively isolating a desired one of the input channels from the remaining channels input into the PINC-BEC. The inventive system further comprises a second PINC-BEC having an input for receiving the remaining channels from an output of the first PINC-BEC and further filtering the desired one of the input channels from the input to the second PINC-BEC.

Preferably, a Bragg grating is disposed between the first and second PINC-BECs to improve the isolation of the selected channel.

In another aspect of the invention, there is provided a device for use in an optical telecommunication network, which comprises a coupler comprised of a pair of optical fibers. Each of the optical fibers has an input and an output, and there is a coupling region between the pair of optical fibers. A Bragg grating is disposed in the coupling region, to form a BEC. A spacing between each of the pair of optical fibers is reduced in the coupling region.

Preferably, a second Bragg grating is disposed on the output portion of one of the pair of optical fibers. In a particularly preferred embodiment, a second coupler is provided, having an input which is optically connected to the output of one of the pair of optical fibers. In this instance, the aforementioned second Bragg grating is disposed between the first and second couplers.

The second coupler, like the first, preferably comprises a pair of optical fibers, each of which has an input and an output. There is a coupling region between the pair of optical fibers, and a Bragg grating disposed in the coupling region.

In still another aspect of the invention, there is provided a device for use in an optical telecommunication network, which comprises a Mach-Zehnder coupler having a pair of outputs, as well as a first PINC optically connected to one of the pair of outputs, and a second PINC optically connected to the other of the pair of outputs.

The invention, together with additional features and advantages thereof, may best be understood by reference to the following description taken in conjunction with the accompanying illustrative drawing.

### BRIEF DESCRIPTION OF THE DRAWINGS

FIG. 1 is a schematic view of a PINC-BEC coupler in accordance with the principles of the present invention;

FIG. 2 is a schematic view of a Dense OADM coupler constructed in accordance with the principles of the present invention;

FIG. 3 is a schematic view of a Mach-Zehnder coupler configuration which has been modified in accordance with the principles of the present invention to include PINC couplers;

FIG. 4 is a schematic view of a Mach-Zehnder coupler configuration which has been modified to an alternative OADM configuration;

FIG. 5 is a schematic view of a high isolation 1 x 2 coupler configuration constructed in accordance with the principles of the present invention; and

FIG. 6 is a Mach-Zehnder coupler configuration in accordance with the present invention, including a pair of PINC couplers cascaded in parallel thereto.

### DESCRIPTION OF THE PREFERRED EMBODIMENT

Referring now more particularly to the drawings, there is shown in FIG. 1 a PINC-BEC coupler 10, which may be manufactured using the process described in U.S. Pat. No. 4,763,272 to McLandrich. PINC couplers are interchangeable with other couplers, such as broadband couplers, 50-50 tap couplers, and Mach-Zehnder couplers, all of which are well known in the art. Broadband couplers may be manufactured in a variety of ways, such as using thin films and waveguides. Advantageously, the inventors have added a Bragg grating 12 to the conventional PINC coupler structure, to decrease the channel spacing, while preserving the advantage of very low excess loss. In the inventive embodiments of the PINC-BEC coupler 10, the difficulties of prior art PINC and BEC couplers are mitigated. For example, the Bragg grating 12 can be made to be a moderate reflector, e.g. from 80-95%. This greatly simplifies the manufacturing process, as the process is terminated before the final steps are completed, and before tight tolerances are required. This process yields a moderate performance device. Manufacturing simplicity is greatly enhanced, and the manufacturing throughput is greatly increased.

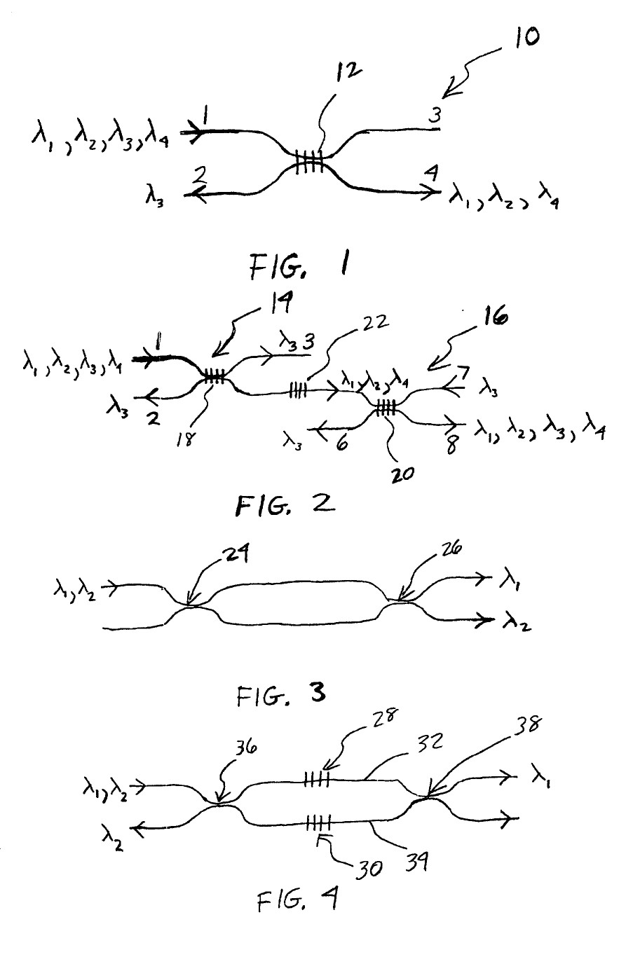

Now with reference to FIG. 2, an important embodiment of the present invention will be discussed. In FIG. 2, there is shown a Dense OADM 13, comprised of two cascaded PINC-BEC couplers 14 and 16, respectively. The PINC-BEC coupler 14 has a Bragg grating 18, and the PINC-BEC coupler 16 has a Bragg grating 20, as in the FIG. 1 embodiment. An additional Bragg grating 22 is disposed at the juncture between the first coupler 14 and the second coupler 16. This unique configuration provides exceptional isolation. Although not as advantageous, as an alternative to the illustrated embodiment, any other known coupler technology could be used instead of the illustrated PINC-BEC couplers.

In the embodiment illustrated in FIG. 2, wherein a second PINC-BEC coupler of the same type as the first is placed in series therewith, the isolation is doubled over what is achievable using the FIG. 1 embodiment, for example. The resultant isolation is equivalent to what is otherwise achievable using expensive high performance systems requiring complex and exacting manufacturing techniques. Further placing a Bragg grating such as grating 22 in line with the first coupler 14 or between couplers 14 and 16, as illustrated, further enhances performance. Using these architectures, excellent isolation is achieved, yet the costs to manufacture such devices are greatly reduced, and performance issues associated with highly reflective devices, such as damage threshold in high signal strength systems, and ringing, are minimized.

A particular advantage of the FIG. 2 embodiment with respect to the PINC-BEC coupler 10 shown in FIG. 1, is that the FIG. 2 system eliminates any wavelength leakage that might occur in the FIG. 1 coupler. For example, in both the FIG. 1 and FIG. 2 systems, a wavelength band comprising λ₁, λ₂, λ₃, and λ₄ enter the port labeled 1. In FIG. 1, because of the grating 12, wavelength 3 is reflected and coupled back through port 2, and wavelengths λ₁, λ₂, and λ₄ are coupled to port 4. However, the grating 12 will typically permit about 2% of λ₃ to leak through to port 4, which of course is an undesirable result. The FIG. 2 embodiment addresses this leakage problem by employing the grating 22, which reflects some of the λ₃ wavelength back through the grating 18, where it is reflected and coupled back through port 3. Then, the grating 20 separates out almost all of the remaining leaked λ₃ wavelength, reflecting it back and coupling it to port 6, as illustrated.

It should be noted that, although the wavelength band λ₁, λ₂, λ₃, and λ₄ is illustrated in connection with the FIG. 2 system, any number of wavelengths λ₁₋ₙ may be input, as desired, and any desired channel may be selected for isolation to a particular output. This is true for any of the systems disclosed herein. Additionally, it is within the scope of the present invention to cascade additional couplers, as desired, to the illustrated systems to achieve desired tolerances and performance.

Optionally, if desired, the system shown in FIG. 2 also functions as an “Add-drop” system. In that respect, as shown, it is possible to add λ₃ wavelength back into the system, in a controlled manner, by adding it so that it enters port 7, and is reflected by the grating 20 to join the output of port 8. Thus, optionally, the system illustrated in FIG. 2 may produce output λ₁, λ₂, and λ₄, as in the FIG. 1 embodiment, though with much better filtering of the 3 wavelength than in the FIG. 1 embodiment, or, alternatively, the output may comprise wavelengths λ₁, λ₂, λ₃, and λ₄, if the λ₃ wavelength is added back in.

Now with reference to FIG. 3, there is shown a Mach-Zehnder coupler which has been modified to include PINC couplers 24 and 26 on each end thereof. The illustrated system functions in a manner similar to that of a PINC coupler, to divide input wavelengths λ₁, λ₂ into separate outputs λ₁ and λ₂. This coupler may be constructed using the process described in the McLandrich '272 patent discussed supra, with the illustrated PINC couplers, or, alternatively, with broadband couplers such as tap couplers, PINC-BEC couplers, or any other such combination. The illustrated device may also be configured as an interleaver where successive pass bands are used to combine or distribute the outputs of other less narrow couplers. Interleaving may also be accomplished using a PINC coupler manufactured with appropriately narrow wavelength spacing.

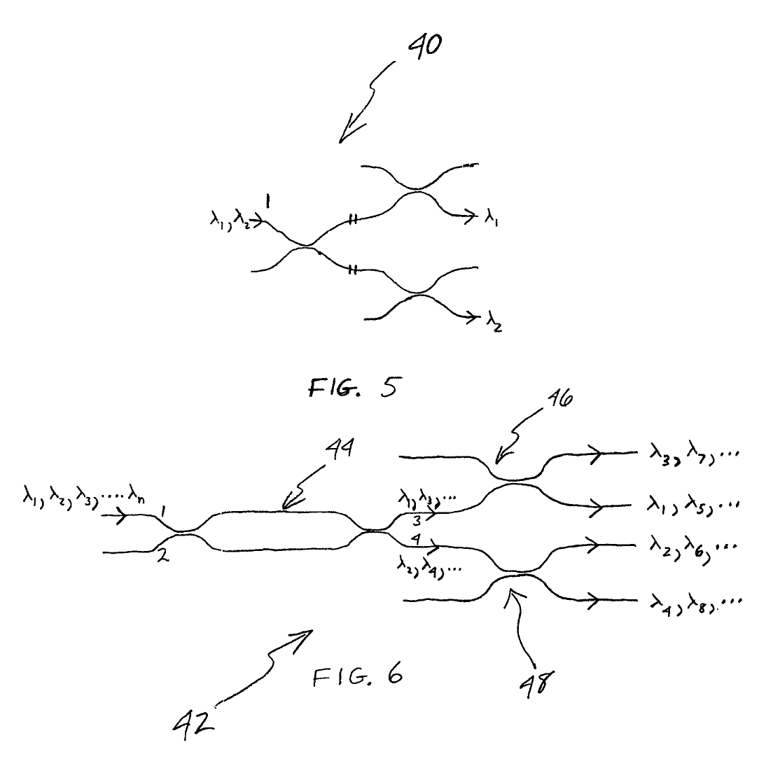

In FIG. 4, there is shown a Mach-Zehnder coupler of the type shown in FIG. 3, but in an alternative OADM configuration. This OADM fimction is accomplished by employing Bragg gratings 28, 30 on each arm 32, 34 of the coupler. It is important that the two gratings 28, 30 are perfectly matched to achieve acceptable results. The usage of PINC couplers 36, 38 in combination with the Mach-Zehnder coupler is unique to this invention.

An issue to be considered is the ability to electrically or thermally tune the wavelength of a coupler or OADM. PINC couplers, PINC-BEC couplers, and Mach Zehnder couplers all can be tuned by mounting them to a suitable material. For example, a piezoelectric material can be controlled electrically, or a ceramic material with the appropriate thermal expansion coefficient can be controlled thermally. An asymmetric approach can be used with the Mach-Zehnder configuration, where the two arms are controlled differently to obtain a larger effect. Yet another possible configuration is a broadband coupler with a Bragg grating under electric or thermal control.

Referring now to FIG. 5, there is shown a higher isolation 1×2 coupler configuration 40, which is obtained by cascading couplers together. The illustrated configuration functions in a manner similar to that of the coupler configuration shown in FIG. 3, to divide an input having wavelengths λ₁, λ₂ into separate outputs λ₁ and λ₂. Because of the cascaded configuration, excellent isolation is achieved. This concept is extendable to larger couplers, such as 1×4 and 1×8 configurations, for example.

FIG. 6 illustrated an important coupler configuration 42 in accordance with the present invention. In this coupler embodiment, a Mach-Zehnder coupler 44 is cascaded with a pair of PINC couplers 46, 48 connected respectively to each of the two outputs 3, 4 of the Mach-Zehnder coupler 44, in parallel. Prior art systems of this type, for generating divided outputs as shown in FIG. 6, are known in the art, but employ cascaded Mach-Zehnder couplers, rather than a single Mach-Zehnder in combination with a pair of PINC's. The advantages of the present configuration are, first, that the PINC's have been found by the inventors to substantially reduce “insertion losses” in the system (meaning the change in light levels in the system after insertion). Second, PINC's are substantially less expensive than Mach-Zehnder's, so there is a sizable cost advantage over the prior art in using the present approach.

Accordingly, although an exemplary embodiment of the invention has been shown and described, it is to be understood that all the terms used herein are descriptive rather than limiting, and that many changes, modifications, and substitutions may be made by one having ordinary skill in the art without departing from the spirit and scope of the invention. It is intended that the scope of the invention be limited not by this detailed description, but rather only by the claims appended hereto.

What is claimed is:

1. A device for use in an optical telecommunication network, comprising:
a first PINC-BEC having an input for receiving channels comprising wavelength bands λ₁₋ₙ where n is a number greater than 2, and a plurality of outputs, said first PINC-BEC having a first Bragg grating for selectively isolating a desired one of said input channels from the remaining channels input into said PINC-BEC; and
a second PINC-BEC having an input for receiving the remaining channels from an output of said first PINC-BEC and further filtering the desired one of said input channels from said input.

2. The device as recited in claim 1, and further comprising a Bragg grating disposed between said first and second PINC-BECs.

3. A device for use in an optical telecommunication network, comprising:
a coupler comprised of a pair of optical fibers, each of said optical fibers having an input and an output;
a coupling region between said pair of optical fibers; and
a Bragg grating disposed in said coupling region.

4. The device as recited in claim 3, wherein a spacing between each of said pair of optical fibers is reduced in said coupling region.

5. The device as recited in claim 3, and further comprising a second Bragg grating disposed on the output portion of one of said pair of optical fibers.

6. The device as recited in claim 3, and further comprising a second coupler having an input which is optically connected to the output of one of said pair of optical fibers.

7. The device as recited in claim 6, and further comprising a second Bragg grating disposed between said first and second couplers.

8. The device as recited in claim 6, wherein said second coupler comprises a pair of optical fibers, each of said optical fibers having an input and an output;
a coupling region between said pair of optical fibers; and
a Bragg grating disposed in said coupling region.

9. A device for use in an optical telecommunication network, comprising:
a Mach-Zehnder coupler having a pair of outputs;
a first PINC optically connected to one of said pair of outputs; and
a second PINC optically connected to the other of said pair of outputs.
